(19) United States
(12) Patent Application Publication
(10) Pub. No.: US 2008/0085358 A1
(43) Pub. Date: Apr. 10, 2008

(54) Oily Food And Method Of Producing The Same

(75) Inventors: Koreta Ueyama, Izumisano-shi (JP); Masayuki Matsui, Tsukubamirai-shi (JP); Hideki Komai, Tsukubamirai-shi (JP)

Correspondence Address: WENDEROTH, LIND & PONACK, L.L.P., 2033 K STREET N. W., SUITE 800, WASHINGTON, DC, 20006-1021, US

(73) Assignee: Daikin Industries, Ltd., Osaka-shi (JP)

(21) Appl. No.: 11/792,522

(22) PCT Filed: Dec. 7, 2005
(86) PCT No.: PCT/JP05/22496

§ 371 Date: Aug. 16, 2007

(30) Foreign Application Priority Data
Dec. 14, 2004 (JP) 2004-360780

(51) Int. Cl. A23D 9/00

(52) U.S. Cl. 426/607

(57) ABSTRACT

[PROBLEMS] To develop an oily food suffering from less worsening in the meltability in the mouth and flavor development, which arises in association with the improvement in heat resistance, and to which the above functions can be imparted by a convenient method.

[MEANS FOR SOLVING PROBLEMS] By controlling the composition rate of SOS to (SOO+SLS+SLO) to a specific level in the fat composition in preparing an oily food, worsening in the meltability in the mouth and flavor development, which arises in association with the improvement in heat resistance, can be lessened. Moreover, an oily food having the above functions imparted thereto can be produced by a convenient method.

### TECHNICAL FIELD

The present invention relates to an oily food, in which worsening in the meltability in the mouth and flavor development, which arises in association with the improvement in heat resistance, is ameliorated and to which the above functions are imparted by a convenient method.

### BACKGROUND ART

An oily food including chocolate takes a structure in which mainly a solid matter derived from cacao or milk, and sugar are dispersed in cocoa butter or hard butter having similar physical properties to those of cocoa butter, and a nature of fat or oil which is a continuous phase greatly influences on an eating feeling and physical properties of chocolate.

Representative examples of fat or oil for chocolate mainly include cocoa butter. Since chocolate containing a large amount of this cocoa butter is rapidly softened at a high temperature of not lower than 25° C., the chocolate is deficient in heat resistance in summer in Japan or at a temperature in tropical countries, such chocolate which has been softened by exposing to a temperature around the melting point is deformed, and loses a crispy eating feeling, resulting in remarkable reduction in a commercial value. For this reason, previously, many ideas for improving heat resistance of an oily food have been tried and, among them, modification of fat or oil has been generally and frequently used.

Fat or oil contains triacylglycerol (hereinafter referred to as TG) as a main component and, inter alia, cocoa butter contains symmetric TG as a main component. The symmetric TG refers to such a kind of TG that saturated fatty acids are bound at the 1- and 3-positions of TG, and an unsaturated fatty acid is bound at the 2-position, cocoa butter contains a large amount of 1,3-distearoyl-2-oleoyl-glycerol (hereinafter, referred to as SOS), 1,3-dipalmitoyl-2-oleoyl-glycerol (hereinafter, referred to as POP), and 1-stearoyl-2-oleoyl-3-stearoyl glycerol (hereinafter, referred to as POS) which are this symmetric TG. Among them, TG having a highest melting point is SOS, and a method of improving heat resistance of an oily food by adding fat or oil rich in this SOS is widely used (e.g. Non-Patent Document 1).

Examples of the fat or oil rich in SOS include fat or oil in which an SOS component is enhanced by fractionating interesterified oil of shea butter, sal fat, illipe butter or high oleic acid containing-sunflower oil and a stearic acid ester.

However, a conventional method of simply enhancing SOS without consideration of other TG components can improve only heat resistance, but has a problem that flavor development (when an oily food is chocolate or a chocolate-like food, development of flavor of cacao of chocolate itself; when an oily food to which other edible substances or a flavor has been added, development of flavor of the edible substances or a flavoring agent) or meltablity in the mouth of an oily food is considerably lost.

On the other hand, a method of using fat or oil having a particular TG composition in which SOS and POS are 80 to 98% and, at the same time, other components such as GGG (G is saturated fatty acid), GGO, OOG and the like are contained, have been devised (e.g. Patent Document 1).

This method is said to be effective for improving bloom or hardness property. However, this absolutely relates to conventional chocolate at that time, that is, a conventional method of improving an oily food for the purpose of imparting heat resistance.

In particular, since chocolate containing a large amount of symmetric TG realizes its excellent flavor development or meltability in the mouth by performing a strict temperature controlling operation for solidification (i.e., so-called tempering), it is not desirable to eliminates flavor development or meltability in the mouth due to improvement in heat resistance.

This is far from accomplishment of an object of the present invention to reduce deterioration of the meltability in the mouth and flavor development, which arises in association with the improvement in heat resistance.

Therefore, a market has strongly demanded to improve heat resistance of an oily food with minimizing sacrifice of flavor development and the meltability in the month of an oily food.

Non-Patent Document 1: Gerard Hogenbirk, “Compatibility of Specialty Fats with Cocoa Butter”, The Manufacturing Confectioner 1984(5) (p. 59-64)

Patent Document 1: JP 49-9507 A (pages 1-33)

### DISCLOSURE OF THE INVENTION

### Problems to be Solved by the Invention

An object of the present invention is to develop an oily food, in which worsening in the meltability in the mouth and flavor development, which arises in association with the improvement in heat resistance, is ameliorated and to which the above functions are imparted by a convenient method.

### Means for Solving the Problems

In order to achieve the above object, the present inventors have intensively studied and, as a result, have found that, by increasing a ratio of SOS in a fat or oil composition of an oily food and, at the same time, suppressing a ratio of three kinds of TG's of 1-stearoyl-2,3-dioleoyl-glycerol (hereinafter, referred to as SOO), 1,3-distearoyl-2-linoleyl-glycerol (hereinafter, referred to as SLS), and 1-stearoyl-2-linoleyl-3-oleoyl-glycerol (hereinafter, referred to as SLO), adding fat or oil in which SOS and (SOO+SLS+SLO) have a particular composition for the suppression, and further, adding the fat or oil to adjust SOS and (SOO+SLS+SLO) at a particular blending ratio in a final fat or oil composition of an oily food, it is possible to obtain an oily food, in which worsening in the meltability in the mouth and flavor development, which arises in association with the improvement in heat resistance, is ameliorated and to which the above functions are imparted by a convenient method. Thus, the present invention has been completed.

That is, the present invention is (1) an oily food comprising 3.0% by weight or more of fat or oil which contains 70% by weight or more of an SOS component, and 11% by weight or less of an SOO+SLS+SLO component, wherein S indicates stearic acid, O indicates oleic acid, and L indicates linoleic acid; and is (2) the oily food according to (1), which has such fat or oil composition that SOS is 30% by weight or more based on the total fat or oil contained therein.

### EFFECT OF THE INVENTION

The present invention is advantageous because it is possible to obtain an oil food in which worsening in the meltability in the mouth and flavor development (capability of development of a flavor of cacao of chocolate itself and a flavor of other edible substances and a flavoring agent), which arises in association with the improvement in heat resistance of the oily food, is ameliorated and to which the above functions can be imparted by a convenient method.

### BRIEF DESCRIPTION OF THE DRAWINGS

FIG. 1 shows a relationship of heat resistance between the existing heat resistance imparting fat or oil SS400 system and SS400F obtained according to the present invention, in which SOS % by weight in a total oily matter in an oily food is on an x-axis, and a rheometer value (g) at 32° C. is on a y-axis.

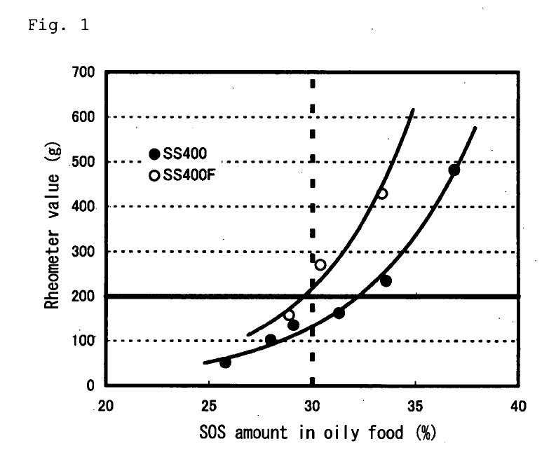

### BEST MODE FOR CARRYING OUT THE INVENTION

The present invention will be explained in more detail below. The oily food referred in the present invention is not particularly limited as far as it is a food in which fat or oil constitutes a continuous phase, and examples thereof includes chocolate and a chocolate-like food. Particularly, the present invention is more effective in “tempering-type” chocolate containing much symmetric TG.

Other compositions and a production method in the present invention is not particularly limited, and a conventional method can be used, as far as an oily food is that containing 3.0% by weight or more of fat or oil which contains 70% by weight or more of an SOS component, and 11% by weight or less of an SOO+SLS+SLO component (this fat or oil is provisionally referred to as fat or oil A).

The origin and production method of fat or oil A is not particularly limited, as far as the above conditions are satisfied. Examples thereof include a method of concentrating an SOS component so as to be in the above defined range, by partially modifying a step of a method of enhancing an SOS component in interesterified oil of shea butter, sal fat, illipe butter or a highly oleic acid-containing-sunflower oil, having a high content of symmetric triglyceride, and a stearic acid ester, which is the existing method of producing high content SOS fat or oil, for example, improving its solvent fractionation precision, using a ratio of a raw material substrate having a high stearin purity upon interesterification, or improving a ratio of a raw material derived form stearin, or a method of enhancing a reaction rate of interesterification.

The heat resistance imparting effect of fat or oil A is higher when an SOS amount is larger, and it is desirable that an SOS content of fat or oil A necessary for enhancing the significant effect at a small amount (not 5% or less) is 70% by weight or more, preferably 75% by weight or more, more preferably 80% by weight or more. When an SOS content of fat or oil A is smaller than the defined content, a larger amount of fat or oil A to be added is required in order to impart the desired heat resistance, and this is not desirable from a viewpoint of a cost. When an SOS content of fat or oil A is extremely small, in some cases, the desired heat resistance can hardly impart even by addition of a largest amount of fat or oil A.

Further, when the above required SOS content of fat or oil A is met and a ratio of SOS/(SOO+SLS+SLO) is higher, the effect becomes further higher, and it is desirable that an SOO+SLS+SLO component is 11% by weight or less. When an SOO+SLS+SLO component exceeds the defined amount, even if heat resistance is improved because the condition of an SOS content is met, the meltability in the mouth and flavor development are remarkably deteriorated, resulting in a damaged commercial value.

When the conditions of a composition/an addition amount of fat or oil A are met, fat or oil components other than fat or oil A in an oily food is not particularly defined. As compared with use of existing high content SOS fat or oil, when heat resistance is improved to the same degree, deterioration of the meltability in the mouth and flavor development can be reduced and, when the same degree of the meltability in the mouth and flavor development are obtained, the heat resistance can be more improved.

As described above, the effect of the present invention is higher in case of an oily food of symmetric-type TG, typically chocolate which is a tempering-type oily food, having a TG composition close to that of cocoa butter. Furthermore, when the heat resistance is imparted to such chocolate using fat or oil A, in order to improve heat resistance of cocoa butter which is a representative of fat or oil for a chocolate by 1° C. or more, it is desirable that SOS in a fat or oil composition of an oily food is 30% by weight or more based on a total amount of fat or oil contained in the oily food. Even when heat resistance is improved to the same degree as that of conventional chocolate, in chocolate in which SOS has reached 30% by weight or more based on a total amount of fat or oil contained therein by using fat or oil which does not meet the definition of fat or oil A, the meltability in the mouth and flavor development are remarkably deteriorated, resulting in a damaged commercial value.

The production method of an oily food is not particularly limited as far as a fat or oil composition of the end product is within the above defined range, or fat or oil A is used in the above defined range, and the oily food can be produced according to a conventional method.

Thus, according to the present invention, it is possible to produce an oily food, in which worsening in the meltability in the mouth and flavor development, which arises in association with the improvement in heat resistance, is ameliorated and to which the above functions are imparted by a convenient method.

### EXAMPLES

The present invention will be explained in more detail by the following Examples, but a spirit of the present invention is not limited to the following Examples. In Examples, % (percents) and parts are by weight. <Comparative Example 1, Comparative Example 2, Comparative Example 3, Comparative Example 4, Comparative Example 5, Comparative Example 6, Comparative Example 7, Example 1, Example 2>

According to Table 2, cacao mass, powdery sugar, cocoa butter, and fat or oil to be tested are blended, and raw material chocolate is produced according to a conventional method.

The fat or oil to be tested were SS400 (trade name: Melano SS400, manufactured by Fuji Oil Company Limited) of tempering-type fat or oil, which was conventionally and often used for imparting heat resistance; and fat or oil (name: SS400F, the product made on experimental basis, manufactured by Fuji Oil Company, Limited) obtained by subjecting a high oleic acid-containing sunflower oil and a stearic acid ester to interesterification with a 1,3-position-specific lipase to introduce stearic acid into a 1- or 3-position of TG, followed by increasing an SOS content by fractionation. Further, cocoa butter (trade name: Cocoa Butter 201, manufactured by Fuji Oil Company Limited) was appropriately blended so that an oily component in chocolate became constant when an amount of the fat or oil to be tested was increased or decreased.

The amounts of SOS and SOO+SLO+SLS in the fat or oil to be tested and cocoa butter are shown in Table 1.

The chocolate produced by a conventional method according to the formulation in Table 2 was accessed for heat resistance and an eating feeling after aging at 20° C. for 1 week.

Heat resistance was accessed by measuring a breakage strength with a rheometer (RHEONER11, manufactured by “Yamaden Co., Ltd.”) after chocolate molded by a mold having a thickness of 5.5 mm was stored at each temperature (30, 31, 32° C.) for 2 hours. For measurement, a plunger having a diameter of 3 mm was used.

TABLE 1

| | SOS | SOO + SLO + SLS (%) |
|---|---|---|
| Cocoa butter | 25.8 | 4.6 |
| SS400 | 65.4 | 13.5 |
| SS400F | 80.4 | 3.9 |

TABLE 2

| Comparative | Comparative | Comparative | Comparative | Comparative | Comparative | Comparative | Example | Example |
|---|---|---|---|---|---|---|---|---|
| Example 1 | Example 2 | Example 3 | Example 4 | Example 5 | Example 6 | Example 7 | 1 | 2 |

Blending (%)

| | | | | | | | | | |
|---|---|---|---|---|---|---|---|---|---|
| Cacao mass | 43 | 43 | 43 | 43 | 43 | 43 | 43 | 43 | 43 |
| Powdery sugar | 45 | 45 | 45 | 45 | 45 | 45 | 45 | 45 | 45 |
| Cocoa butter | 12 | 10 | 9 | 7 | 5 | 2 | 10 | 9 | 7 |
| SS400 | — | 2 | 3 | 5 | 7 | 10 | — | — | — |
| SS400F | — | — | — | — | — | — | 2 | 3 | 5 |
| Lecithin | 0.4 | 0.4 | 0.4 | 0.4 | 0.4 | 0.4 | 0.4 | 0.4 | 0.4 |

Heat resistance (g)

| | | | | | | | | | |
|---|---|---|---|---|---|---|---|---|---|
| 30° C. | 648 | 795 | 836 | 984 | 1076 | 1310 | 969 | 1172 | 1382 |
| 31° C. | 204 | 300 | 331 | 413 | 515 | 699 | 403 | 576 | 760 |
| 32° C. | 51 | 102 | 135 | 163 | 235 | 482 | 158 | 271 | 429 |

Composition (%)

| | | | | | | | | | |
|---|---|---|---|---|---|---|---|---|---|
| SOS | 25.8 | 28.0 | 29.1 | 31.3 | 33.6 | 36.9 | 28.9 | 30.4 | 33.4 |

*An assessment method is organoleptical assessment of change in an eating feeling by 10 panelists.

The rheometer value (413 g) at 31° C. of Comparative Example 4 in which cocoa butter is replaced with 5 parts of the conventional type SS400 is approximately equal to the rheometer value (429 g) at 32° C. of Example 2 in which cocoa butter is replaced with 5 parts of SS400F having an increased SOS content and having an decreased SOO+SLO+SLS content. Therefore, Example 2 is considered to be improved in heat resistance by about 1° C. as compared with Comparative Example 4, that is, SS400F is improved in heat resistance by about 1° C. as compared with SS400, by replacement of the conventional type SS400 with the same amount of novel SS400F.

In the conventional type SS400 in which an SOS component is less than 70% by weight, and an SOO+SLS+SLO component exceeds 11% by weight, heat resistance is improved as a replacement amount is increased in the order of Comparative Example 2 (replacement amount 2.0), Comparative Example 3 (replacement amount 3.0), Comparative Example 4 (replacement amount 5.0), and Comparative Example 5 (replacement amount 7.0), but the meltability in the mouth and flavor development are remarkably deteriorated.

On the other hand, as with SS400, SS400F in which an SOS component is 70% by weight or more, and an SOO+SLS+SLO component is 11% by weight or less improves heat resistance as a replacement amount is increased in the order of Comparative Example 7 (replacement amount 2.0), Example 1 (replacement amount 3.0), and Example 2 (replacement amount 5.0).

However, as compared with replacement of the same amount of SS400, not only the greater heat resistance is imparted, but also the meltability in the mouth and flavor development are better when SS400 is replaced so that the same degree of heat resistance is imparted.

Further, while SOS %'s in chocolate are almost the same degree in Comparative Example 5 (SOS in chocolate=33.6%) in which replacement with 7 parts of SS400, and Example 2 (33.4%) in which replacement with 5 parts of SS400F, heat resistance of Example 2 is comparable to that of Comparative Example 6 in which replacement with 10 parts of SS400. At other replacement amounts, as compared with a system in which heat resistant is improved with SS400, the meltability in the mouth and flavor development are better in the case of the same degree of improvement in heat resistance, or heat resistance is increased at the same degree of SOS content with maintaining the better meltability in the mouth/flavor capability of development in cases of a system in which heat resistance is improved by SS400F.

As described above, heat resistance is improved as increased in an amount of replacement between cocoa butter and heat resistance-imparting fat or oil which contains an SOS as a main component. However, the heat resistance imparting effect is logarithmically increased. Then, even when SS400F is used, in Comparative Example 7 in which a replacement amount is 2.0% by weight, an addition amount is too small. Then, not only the heat resistance imparting effect is deficient, but also the effect such as heat resistance impartation, better meltability in the mouth, capability of flavor development is reduced as compared with the conventional type fat or oil.

In addition, when heat resistance of chocolate is improved by 1° C. or more as compared with cocoa butter, the effective improving effect as a commercial good is recognized, and 30% by weight or more of an SOS amount in an oily food is necessary in order to improve heat resistance by 1° C. or more using SS400F in view of the above data.

### INDUSTRIAL APPLICABILITY

According to the present invention, it is possible to produce an oily food, in which worsening in the meltability in the mouth and flavor development, which arises in association with the improvement in heat resistance, is ameliorated and to which the above functions are imparted by a convenient method.

1. An oily food comprising 3.0% by weight or more of fat or oil which contains 70% by weight or more of an SOS component, and 11% by weight or less of an SOO+SLS+SLO component, wherein S indicates stearic acid, 0 indicates oleic acid, and L indicates linoleic acid.

2. The oily food according to claim 1, which has such fat or oil composition that SOS is 30% by weight or more based on the total fat or oil contained therein.
